(19) United States
(12) Patent Application Publication
(10) Pub. No.: US 2019/0153690 A1
(43) Pub. Date: May 23, 2019

(54) AUTOMATIC REMOVE EQUIPMENT FOR DISASTER BLOOMING MARINE ORGANISMS OF SEA WATER INTAKE CHANNEL

(71) Applicant: DALIAN UNIVERSITY OF TECHNOLOGY, Liaoning (CN)

(72) Inventors: Kui YOU, Liaoning (CN); Caihua MA, Liaoning (CN); Honggang MA, Liaoning (CN); Xintian LIU, Liaoning (CN); Chen HOU, Liaoning (CN); Yongfei LIU, Liaoning (CN); Zewen CHEN, Liaoning (CN); Yuyu ZHANG, Liaoning (CN); Jing DONG, Liaoning (CN); Fang ZHANG, Liaoning (CN); Ling ZHU, Liaoning (CN); Chaolun LI, Liaoning (CN); Zhenhua YAO, Liaoning (CN); Anyi CHEN, Liaoning (CN); Zehao ZHANG, Liaoning (CN); Shiwen HE, Liaoning (CN)

(21) Appl. No.: 16/094,322

(22) PCT Filed: Apr. 28, 2017
(86) PCT No.: PCT/CN2017/082452

§ 371 Date: Feb. 1, 2019

(30) Foreign Application Priority Data
Jun. 30, 2016 (CN) 201610494725.X

(51) Int. Cl. E02B 15/10; B63B 35/32; E02B 15/08; C02F 1/40

(52) U.S. Cl. CPC E02B 15/10; B63B 35/32; C02F 2103/007; C02F 1/40; E02B 15/0814

(57) ABSTRACT

Automatic remove equipment for disaster blooming marine organisms of sea water intake channel belongs to the field of marine environmental engineering and equipment. The equipment comprises a cod-end of collecting net, a saw blade at the end of net, a fixation and support system, a submersible spiral pump, a transport pipe system, a separating system on coast and floats. The equipment collects the disaster blooming marine organisms in the sea water channel into the bottom of a cod-end of collecting net, and cuts and decomposes the collected disaster blooming marine organisms by using a saw blade at the end of net under the combined action of the water flow power and the suction pressure of a submersible spiral pump. Fragments after cutting are sucked by the submersible spiral pump and delivered to a coast, and are subjected to solid-liquid separation by a separating system on coast and then are centrally disposed. The equipment is sturdy and durable and can resist corrosion of the sea water environment; and the equipment can efficiently collect and remove the disaster blooming marine organisms in the industrial sea water intake channel automatically, thereby saving labor cost, ensuring normal operation of the industrial system and increasing production benefits.

### TECHNICAL FIELD

The present invention belongs to the technical field of marine environment engineering and equipment, and relates to automatic remove equipment for disaster blooming marine organisms of a sea water intake channel.

### BACKGROUND

Nowadays, with the development and progress of social economy, various natural resources are becoming increasingly deficient and scarce. Water resource is no exception. The shortage and serious situation of fresh water resources are worldwide problems. People are forced to use water resources from approximate endless sea water resources, and especially industrial cooling water without special desalination treatment; and sea water can be directly used as cooling water. It is common for various offshore industrial enterprises to use sea water as cooling water, which can save a lot of fresh water resources without building large cooling towers, while endless cooling sea water is used as a substitute to save a lot of construction investment cost and labor cost. Therefore, it is common to directly apply the sea water as the cooling water in large industrial and mining enterprises such as offshore nuclear power plants, thermal power plants, iron and steel plants, etc.

The use of sea water cooling will inevitably bring a large amount of waste heat into natural sea water, thereby raising the temperature of the cooled and discharged sea water. In order to reduce the pollution caused by human factors to the natural marine ecosystem China's sea water quality standard stipulates that the man-made temperature rise shall not exceed 4° C. Even so, the limited human factors lead to the temperature rise, and also generate great impact on the marine ecosystem. The typical performance is causing some special marine organisms to centrally bloom in a certain season. These blooming marine organisms will affect the cooling systems of the industrial and mining enterprises in turn, causing disasters and resulting in great economic loss. The kinds of the disaster blooming marine organisms are different in different sea areas in the north and the south. The disaster blooming marine organisms mainly include jellyfish, echinoderms, acetes and some small fishes and shrimps, etc. Once the disaster blooming marine organisms bloom in disaster, a large number of disaster blooming marine organisms are often generated, and will gather together to dozens of tons within a short time. Once the disaster blooming marine organisms pour into the cooling system of an industrial facility, the disaster blooming marine organisms will block a pipeline and is difficult to remove in time, forcing the cooling system to completely stop operating, further resulting in the entire industrial system to completely paralyze and stop production and causing huge economic loss. Especially for large cooling sea water users such as offshore nuclear power plants and thermal power plants, this phenomenon is extremely common and occurs almost every year. However, there is no good solution.

In general, dedicated sea water intake channels are constructed by large industrial sea water users. In the face of a large number of disaster blooming marine organisms, a plurality of blocking nets are usually disposed in the sea water intake channel to block the disaster blooming marine organisms from entering the cooling system. However, a large number of centrally blooming marine organisms often overburden these blocking nets until the blocking nets are burst and damaged. These disaster blooming marine organisms sometimes reach tens of tons within hours, and it is too late or ineffective to remove the disaster blooming marine organisms through manual dredging. At present, various nuclear power plants, thermal power plants and other enterprises can only perform passive monitoring and interception or take limited control measures such as removal through manual dredging for the problem that the disaster blooming marine organisms block the cooling system. Once the disaster blooming marine organisms enter the cooling system, there is basically no effective control measure. The cooling system shall be shut down and stop production, and will return to normal production after manual removal is completed. At present, relevant patent technologies and reports about the solution of these problems do not exist, and belongs to the field of the technical gap.

### SUMMARY

To solve the above problems in the prior art and achieve the purpose of automatically centralizing and removing the disaster blooming marine organisms, to protect safe operation of the industrial system, the present invention provides an automatic remove equipment for disaster blooming marine organisms of a sea water intake channel. The equipment collects the disaster blooming marine organisms in the sea water channel into the bottom of a cod-end of collecting net, and cuts and decomposes the collected disaster blooming marine organisms by using a saw blade at the end of net under the combined action of the water flow power and the suction pressure of a submersible spiral pump. Fragments after cutting are sucked by the submersible spiral pump and delivered to a coast, and are subjected to solid-liquid separation by a separating system on coast and then are centrally disposed.

To solve the problems, the present invention adopts the following technical solution:

An automatic remove equipment for disaster blooming marine organisms of a sea water intake channel comprises a cod-end of collecting net, a saw blade at the end of net, a fixation and support system, a submersible spiral pump, a location indicator buoy, a transport pipe system and a separating system on coast. A net port of the cod-end of collecting net is combined with a bottom edge and a side edge of a cross section of a water intake channel; and the highest position of the net port of the cod-end of collecting net combined with the side edge of the cross section of the water intake channel is higher than the height of a tidal level of extreme high water of the sea area. An upper edge of the net port is supported by some floats and fluctuating with the tide, thereby intercepting the cross section of the water channel and does not reserve a dead angle. The cod-end of collecting net encircles an area which is gradually decreased from the net port to a net end; the net end is placed below the water level in the water intake channel and is fixed to the saw blade at the end of net; the saw blade at the end of net is connected with a water inlet of the submersible spiral pump through a flange; the submersible spiral pump is installed on the fixation and support system; the location indicator buoy is connected with the fixation and support system; and the transport pipe system is a steel wire armoured high pressure rubber hose, and is connected with an outlet of the submersible spiral pump and a feeding port of the separating system on coast through flanges. The disaster blooming marine organisms are subjected to solid-liquid separation by the separating system on coast, and solid matter is centrally treated, which can not affect and damage the industrial system again.

The saw blade at the end of net is composed of annular cutting edges, horizontal cutting edges and vertical cutting edges; the horizontal cutting edges and the vertical cutting edges are crossed to form a plurality of grids; and the margins of the grids are connected with the annular cutting edges. The side length of each grid can be designed into 2-10 cm. All the cutting edges are serrate; and the height of each sawtooth is 5-10 mm. The diameter of the water inlet of the submersible spiral pump is greater than 10 cm.

The fixation and support system adopts a bottom supported submersible platform or an anchor mooring platform.

The present invention has the beneficial effects: the equipment is sturdy and durable and can resist corrosion of the sea water environment; and the equipment can efficiently collect and remove the disaster blooming marine organisms in the sea water intake channel automatically.

### BRIEF DESCRIPTION OF THE DRAWINGS

FIG. 1 is a schematic diagram of the equipment of the present invention.

FIG. 2 is an enlarged schematic diagram of a saw blade at the end of net of the present invention.

In the figures: 1 cod-end of collecting net; 2 saw blade at the end of net; 3 fixation and support system; 4 submersible spiral pump; 5 coast of sea water intake channel; 6 location indicator buoy; 7 transport pipe system; and 8 separating system on coast.

### DETAILED DESCRIPTION

Specific embodiments of the present invention are described in detail in combination with the technical solution and drawings.

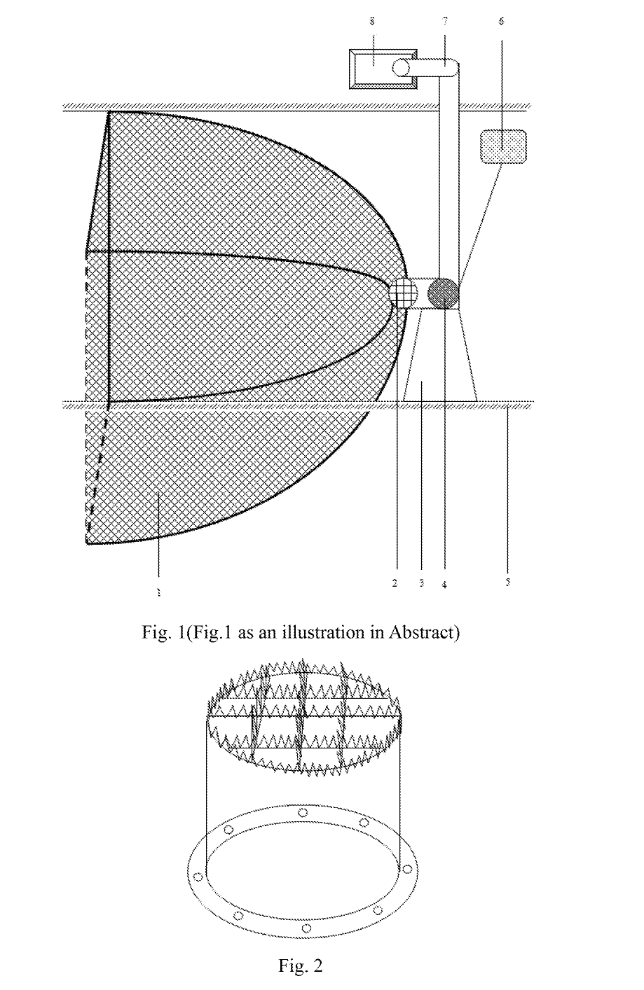

An automatic remove equipment for disaster blooming marine organisms of a sea water intake channel in the present invention comprises a cod-end of collecting net 1, a saw blade at the end of net 2, a fixation and support system 3, a submersible spiral pump 4, a location indicator buoy 6, a transport pipe system 7 and a separating system on coast 8, as shown in FIG. 1.

The saw blade at the end of net 2 is composed of annular cutting edges, horizontal cutting edges and vertical cutting edges, as shown in FIG. 2.

The cod-end of collecting net 1 is arranged according to the shape of the water intake channel in a narrow and flat section of the sea water intake channel. A net port of the cod-end of collecting net is closely combined with a bottom edge and a side edge of the cross section of the water intake channel (which is usually in a shape of a ladder). The close combination means that the net port is generally provided with a net rope (i.e., a thick rope); the net rope is buried into the bottom of the channel and a coast ramp of the channel; or the net rope is buried and fixed in several points to unbend the net rope. The highest point of the combining position of the net port with the side edge of the cross section of the water intake channel is higher than the height of a tidal level of extreme high water of the sea area; an upper edge of the net port is supported by some floats and fluctuating with the tide, i.e., the net port of the cod-end of collecting net closely intercepts the cross section of the water intake channel and does not reserve a dead angle. The side length of the meshes of an equilateral quadrilateral of the cod-end of collecting net 1 is less than 0.4 time of an average diameter of cylindrical somatotypes of the designed to-be-intercepted disaster blooming marine organisms, so as to intercept and remove most of the disaster blooming marine organisms.

The cod-end of collecting net 1 encircles an area which is gradually decreased from the net port to a net end backwards; and the net end is placed below the water level in the water intake channel and is fixed to the saw blade at the end of net 2. The specific manner is as follows; the net end is gradually contracted and reduced, and finally is curled on a ring. The ring can be fixed to an outer wall of saw blade, or to a flange, or is used as a cushion layer of the flange. The saw blade at the end of net 2 is connected with a water inlet of the submersible spiral pump 4 through the flange. The saw blade at the end of net 2 is a latticed saw blade composed of annular cutting edges, horizontal cutting edges and vertical cutting edges. The side length of each grid is 2-10 cm. All the cutting edges are serrate; and the height of each sawtooth is 5-10 mm. A large number of disaster blooming marine organisms are centralized towards the bottom of a cod-end of collecting net under the combined action of the water flow power and the suction pressure of the submersible spiral pump according to the gradually contracted shape of the cod-end of collecting net. The saw blade at the end of net cuts the disaster blooming marine organisms into fragments smaller than maximum objects sucked by the submersible spiral pump.

The submersible spiral pump 4 is installed on the fixation and support system 3. The submersible spiral pump 4 uses electric power as driving force. The suction height of the submersible spiral pump 4 is greater than 5 m, and the lift is greater than 25 m. The diameter of the water inlet is greater than 10 cm. The fixation and support system 3 is connected with the location indicator buoy 6. The fixation and support system 3 is disposed in the middle position of a mean depth of water of the water intake channel; and a bottom supported submersible platform or an anchor mooring platform is adopted. Safety design requires that the fixation and support system 3 has the capability of resisting typhoon attack in 50 years.

The transport pipe system 7 is a steel wire armoured high pressure rubber hose, and is connected with an outlet of the submersible spiral pump 4 and a feeding port of the separating system on coast 8 through flanges. The disaster blooming marine organisms are subjected to solid-liquid separation by the separating system on coast, and solid matter is centrally treated, so that the disaster blooming marine organisms can not affect and damage the industrial system again.

Various members of the automatic remove equipment of the present invention are made of polymer material, high strength engineering plastic or duplex stainless steel.

Under the condition that the disaster blooming marine organisms are greatly different in sizes, the automatic remove equipment designed by the present invention can provide multistage tandem service. Under this condition, the sizes of all stages of cod-ends of collecting nets are gradually decreased according to the discrete distribution situation of the sizes of the disaster blooming marine organisms. The first stage automatically removes the disaster blooming marine organisms with large somatotypes at first, and the second stage automatically removes the disaster blooming marine organisms smaller than the sizes of the disaster blooming marine organisms of the first stage, and so on until the disaster blooming marine organisms are completely removed. The equipment of the present invention realizes tandem service stage by stage from large to small according to the sizes of the meshes of the cod-ends of collecting nets, has preferable remove effect, alleviates remove pressure during single-stage use, and avoids potential accidents such as burst of the cod-ends of collecting nets, blockage of the submersible spiral pump and the like.

1. An automatic remove equipment for disaster blooming marine organisms of a sea water intake channel, wherein it comprises a cod-end of collecting net, a saw blade at the end of net, a fixation and support system, a submersible spiral pump, a location indicator buoy, a transport pipe system and a separating system on coast, wherein a net port of the cod-end of collecting net is combined with a bottom edge and a side edge of a cross section of a water intake channel; the highest position of the net port of the cod-end of collecting net combined with the side edge of the cross section of the water intake channel is higher than the height of a tidal level of extreme high water of a sea area; an upper edge of the net port is supported by floats and fluctuates with the tide; the cod-end of collecting net encircles an area which is gradually decreased from the net port to a net end; the net end is placed below the water level in the water intake channel and is fixed to the saw blade at the end of net; the saw blade at the end of net is connected with a water inlet of the submersible spiral pump through a flange; the submersible spiral pump is installed on the fixation and support system; the location indicator buoy is connected with the fixation and support system; and the transport pipe system is a steel wire armoured high pressure rubber hose, and is connected with an outlet of the submersible spiral pump and a feeding port of the separating system on coast through flanges.

2. The automatic remove equipment for disaster blooming marine organisms of the sea water intake channel according to claim 1, wherein the saw blade at the end of net is composed of annular cutting edges, horizontal cutting edges and vertical cutting edges; the horizontal cutting edges and the vertical cutting edges are crossed to form a plurality of grids; and the margins of the grids are connected with the annular cutting edges.

3. The automatic remove equipment for disaster blooming marine organisms of the sea water intake channel according to claim 2, wherein the side length of the grids of the latticed saw blade is 2-10 cm.

4. The automatic remove equipment for disaster blooming marine organisms of the sea water intake channel according to claim 2, wherein all the cutting edges are serrate; and the height of each sawtooth is 5-10 mm.

5. The automatic remove equipment for disaster blooming marine organisms of the sea water intake channel according to claim 1, wherein the side length of meshes of the cod-end of collecting net is less than 0.4 time of an average diameter of cylindrical somatotypes of the to-be-intercepted disaster blooming marine organisms.

6. The automatic remove equipment for disaster blooming marine organisms of the sea water intake channel according to claim 4, wherein the side length of meshes of the cod-end of collecting net is less than 0.4 time of an average diameter of cylindrical somatotypes of the to-be-intercepted disaster blooming marine organisms.

7. (canceled)

8. The automatic remove equipment for disaster blooming marine organisms of the sea water intake channel according to claim 1, wherein the diameter of the water inlet of the submersible spiral pump is greater than 10 cm.

9. The automatic remove equipment for disaster blooming marine organisms of the sea water intake channel according to claim 4, wherein the diameter of the water inlet of the submersible spiral pump is greater than 10 cm.

10. The automatic remove equipment for disaster blooming marine organisms of the sea water intake channel according to claim 5, wherein the diameter of the water inlet of the submersible spiral pump is greater than 10 cm.

11. The automatic remove equipment for disaster blooming marine organisms of the sea water intake channel according to claim 1, wherein the fixation and support system is disposed in the middle position of a mean depth of water of the water intake channel; and a bottom supported submersible platform or an anchor mooring platform is adopted.
